(19) United States
(12) Patent Application Publication
(10) Pub. No.: US 2009/0125661 A1
(43) Pub. Date: May 14, 2009

(54) SYSTEM FOR SECURE TRANSACTIONS OF CARD-BORNE VALUE UNITS

(75) Inventors: Thierry D'Athis, Versailles (FR); Philippe Dailly, Etrechy (FR); Denis Ratier, Draveil (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neilly Sur Seine (FR)

(21) Appl. No.: 12/158,956

(22) PCT Filed: Dec. 8, 2006
(86) PCT No.: PCT/EP2006/069499

§ 371 Date: Sep. 25, 2008

(30) Foreign Application Priority Data
Dec. 23, 2005 (FR) 05 13216

(51) Int. Cl. G06F 13/00

(52) U.S. Cl. 710/301

(57) ABSTRACT

The invention relates to a system for secure transactions of card-borne value units. The system comprises a card peripheral device for setting up a link with the card and comprising a transparent mode, a terminal linked to the card peripheral device, a host device linked to the terminal. The host device comprises a transactional application suitable for processing the value units on the card and cryptographic means making it possible to read and/or write values units and other information on the card. The card peripheral device operates in transparent mode. The terminal redirects the information originating from or addressed to the card peripheral device to the host device. The host device dialogs with the card via commands and data interchanges. In particular, the invention applies to the topping-up of a chip card, notably from computer means available to the user in possession of said card and an ordinary chip card reader.

### CROSS REFERENCE TO RELATED APPLICATIONS

The present Application is based on International Application No. PCT/EP2006/069499, filed on Dec. 8, 2006, which in turn corresponds to French Application No. 0513216 filed on Dec. 23, 2005, and priority is hereby claimed under 35 USC §119 based on these applications. Each of these applications are hereby incorporated by reference in their entirety into the present application.

### FIELD OF THE INVENTION

The invention relates to a system for secure transactions of card-borne value units. In particular, the invention applies to the topping-up of a chip card, notably from computer means available to the user in possession of said card and an ordinary chip card reader.

### BACKGROUND OF THE INVENTION

Card usage, notably the usage of chip cards, tends to be generalized as a support for value units. For example, in the case of shared transport means, these cards enable the users to have access to the transport means by passing said cards over readers placed at station or vehicle entry points. The card comprises value units corresponding, for example, to different types of subscription or to agreements notably according to the geographical area covered, the quality of the user, the duration or even the number of journeys bought.

The cards therefore need to be able to be loaded or topped up with value units, for example when the user wants to buy new rights of access to certain services for example. These value units, once acquired, are entered into the card. Particular security measures must therefore be implemented in order to prevent any fraudulent use of the value units, such as, for example, the unauthorized addition of new value units that have not been paid for. For this, there are secure card reading and writing systems, deployed, for example, in terminals or access points within stations, or even mobile terminals available to the controllers.

However, the secure card reading and writing systems include sensitive information that cannot be made available to all users: this explains why these systems are in contact with the users in controlled places and their limited circulation to the personnel needed to operate them. This problem is particularly acute for the implementation of a secure transactional system enabling a card to be loaded remotely with value units from, for example, a particular but uncontrolled computer in a user's home.

Furthermore, these secure systems require the use of secure card readers comprising the cryptographic elements needed to access the card. Now, these card readers are more expensive and less widely used than ordinary unsecured card readers.

### SUMMARY OF THE INVENTION

The aim of the invention is notably to overcome the abovementioned drawbacks. To this end, the subject of the invention is a system for secure transactions of value units, borne by a card. The transaction system comprises:
a card peripheral device for setting up a link with said card and comprising a transparent mode;
a terminal linked to the card peripheral device by a link;
a host device, linked to the terminal by a link, comprising a transactional application suitable for processing the value units on said card, cryptographic means making it possible to read and/or write value units and other information on said card.
   The card peripheral device operates in transparent mode, with the terminal redirecting the information originating from or addressed to the card peripheral device to the host device. The host device dialogs with the card via commands and data interchanges via the various links according to communication protocols suited to the card.

In one embodiment, the host device coordinates the secure interchanges used for mutual authentication with the card. The host device can authenticate the holder of the card using means present on the terminal. The host device can also authenticate the terminal.

In a particular embodiment, the card peripheral device is a card reader suitable to reading/writing information on the card, the terminal being a personal computer connected by usual means to the Internet. The host device is a front-end of a central system of one or more service providers operating on the card. The user connects using his personal computer via the link that uses the Internet to the site comprising a transactional application supported by the front-end of his service provider. The transactional application, after insertion of the card of the user into the card reader, proceeds to load the card with the data needed to use the service.

Advantageously, the terminal and the card peripheral device are included in a self-service terminal. The host device is a front-end of a central system of one or more service providers operating on the card.

Advantageously, the terminal can be a personal digital assistant equipped with or connected to a card peripheral device. The terminal is then provided with a link. The host device is then a transactional device permanently or occasionally connected with the central system of one or more service providers operating on the card.

Notable advantages of the invention are that it makes it possible to impose no security constraint on the terminal or on the card reader peripheral device. Furthermore, the card reader peripheral device does not need to store or access any secret, and can therefore be more easily distributed and used in an unsecure location.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, a block diagram representing an inventive system for secure transactions of card-borne value units;

FIG. 2, a block diagram representing an inventive system for secure transactions of card-borne value units supporting procedures by a user in his home;

FIG. 3, a block diagram representing an inventive system for secure transactions of card-borne value units implemented within an unsupervised sales machine.

### DETAILED DESCRIPTION OF THE DRAWINGS

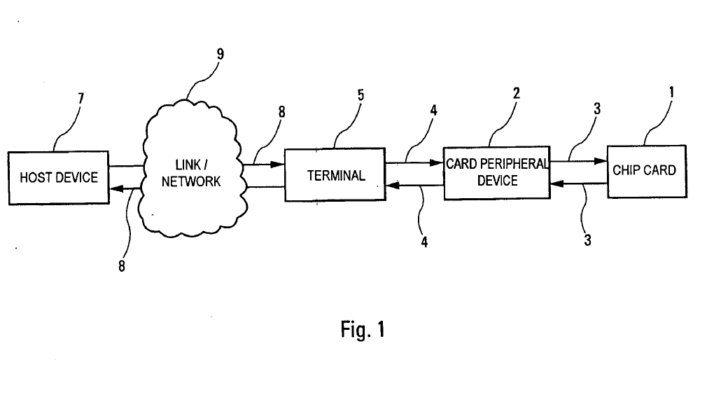

FIG. 1 is a block diagram showing an inventive system for secure transactions of card-borne value units. The system also comprises a card peripheral device 2, a terminal 5 and a host device 7.

The function of the card peripheral device 2 is notably to set up a link 3 with a card 1. The card 1 comprises value units in the form of information protected, for example, by access keys to the card 1, making it possible to secure access to said information. The card 1 can be a chip card, a magnetic card or even a radiofrequency identification card (RFID). The link 3 which is set up between the card peripheral device 2 and the card 1 can be made with or without contact. Furthermore, the link 3 is generally of episodic type. The protocol employed for the link 3 notably depends on the type of card 1 employed. However, there is no particular constraint to guide the choice of the protocol to be employed. The card peripheral device 2 conforms to the specification of the supplier of the card 1. The card peripheral device 2 also comprises a so-called transparent mode. In the inventive system for secure transactions of card-borne values, the card peripheral device 2 operates in transparent mode. In transparent mode, the data traveling from the card 1 to the card peripheral device 2 via the link 3 can be read directly without modifying the data flows circulating over the link 3. Similarly, in transparent mode, the data transmitted to the card peripheral device 2 can be written into the card 1 directly and without modification. The transparent mode of the card peripheral device 2 therefore makes it possible to access the digital interchanges with the card 1. The card peripheral device 2 does not access the information transmitted by the card 1 or the information to be transmitted to the card 1. When the card peripheral device 2 operates in transparent mode, the card peripheral device 2 does not decode the information originating from or addressed to the card 1. The card peripheral device 2 does not therefore necessarily include secret elements enabling the information on the card 1 to be accessed or read. The link 3 therefore requires no specific protection means. In practice, the information originating from or addressed to the card 1 is protected by access keys to the card and does not therefore require additional protection.

The function of the terminal 5 is notably to redirect or route the information originating from or addressed to the card peripheral device 2 obtained from the card 1 to the host device 7. The terminal 5 can be a roaming terminal or a remote terminal. The terminal 5 comprises communication interfaces. Furthermore, the terminal 5 can, for example, be a computer linked to the Internet. The terminal 5 is linked to the card peripheral device 2 by a link 4. The link 4 between the terminal 5 and the card peripheral device 2 does not need to be protected. The protocol used for the link 4 depends on the card peripheral device model used. In a particular embodiment, the terminal 5 comprises a remote man/machine interface if the transactional application with the card requires inputs or outputs with the user of the terminal, that is, with the cardholder or an agent. The terminal 5 can also include other applications, without restriction, these applications being able, for example, to be interfaced with the host device.

The host device 7 includes a transactional application suitable for processing the value units of the card 1, cryptographic means (such as cash dispenser keys for example enabling communication with the card 1) making it possible to read and/or write value units and other information on the card 1, and communication interfaces. The host device 7 is linked to the terminal 5 by a link 8. The link 8 between the host device 7 and the terminal 5 does not need to be protected. In practice, the information originating from or addressed to the card 1 are not protected by the access keys to the card and does not therefore require additional protection. The protocol used for the link 8 depends on the link or the network 9 between the host device 7 and the terminal 5. The network 9 can, for example, be an IP network, Internet, a GPRS network, a WIFI or bluetooth link or a network having any application or proprietary protocol. The host device 7 is therefore subject to security constraints relating to the various sensitive elements that it includes, such as, notably, the access keys to the card 1 or the transactional application. The commands and data interchanges notably passing over the link 8, the link 4 and the link 3 between the host device 7 and the card 1 are compatible and/or compliant with the communication protocols suited to the card 1, more particularly regarding security and the cryptographic elements. The host device 7 coordinates all the secure interchanges used for mutual authentication with the card 1 and, if necessary, to enable the holder of the card 1 to be authenticated using means present on the terminal 5, such as, for example, a man/machine interface present on the data input terminal 5, or biometric means. When the host device 7 dialogs via the link 9 with the terminal 5, the host device 7 is responsible for authenticating the terminal 5 and, if necessary, the user of the terminal 5, even the concomitance with the link 3 with the associated card 1.

The card 1 is a card holding value units or identifies an account holding value units. The card 1 can, for example, be used as an electronic purse, a bank card, a ticket card for public transport or any other service, a town card giving access to a set of services, a loyalty card or any other card bearing value units or identify an account bearing value units.

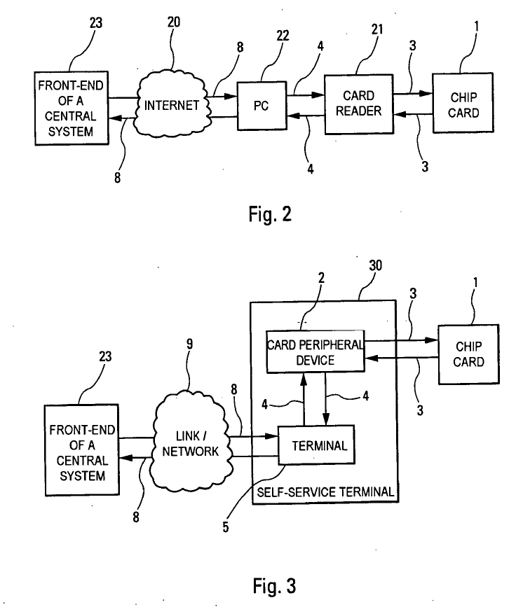

FIG. 2 is a block diagram showing an inventive system for secure transactions of card-borne value units allowing for procedures to be carried out by a user in his home. The elements that are identical to the elements already described in the other figures are given the same references. The inventive system presented in FIG. 2 shows an embodiment of the inventive system shown in FIG. 1 adapted to procedures carried out by a user in his home.

The inventive system for secure transactions presented in FIG. 2 illustrates an architecture enabling, for example, a user to debit and/or top up his card with value units in his home. The card peripheral device 2 used is a card reader 21. This card reader 21 can, for example, be a market-standard reader bought or leased by a user. The card reader 21 does not necessarily include any cryptographic element. The card reader 21 is suitable for reading/writing information on the card 1 and is therefore compatible with the latter. The card reader 21 comprises a transparent mode. The terminal 5 is a personal computer 22 connected by usual means to the Internet. The host device 7 is a front-end of a central system 23 of one or more service providers operating on the card 1.

The user connects using his personal computer 22 via a link 8 that uses the Internet 20 to the site comprising a transactional application supported by the front-end 23 of his service provider. The user can thus order the desired service. The transactional application can then prompt the user to insert his card 1 into the card reader 21 linked to his personal computer to load the card 1 with the data needed to use the service, that is, value units. The card 1 can also be a bank card or even an electronic purse, so enabling additional banking functions to be used. The application can also include a set of means for authenticating the user, such as, for example, a man/machine interface prompting for a code to be input.

FIG. 3 is a block diagram showing an inventive system for secure transactions of card-borne value units implemented within an unsupervised sales machine. The elements that are identical to the elements already described in the other figures are given the same references. The inventive system presented in FIG. 3 shows an embodiment of the inventive system presented in FIG. 1 suited to an unsupervised sales machine.

The inventive system for secure transactions presented in FIG. 3 illustrates an architecture that can be implemented, for example, within a self-service terminal 30 in an unsupervised location. The self-service terminal 30 comprises a card peripheral device 2 comprising a transparent mode, and not necessarily including any cryptographic element. The self-service terminal comprises a terminal 5 provided, if necessary, with a man/machine interface. The host device 7 is a front-end of a central system 23 of one or more service providers operating on the card 1.

In an embodiment, the inventive system for secure transactions of card-borne value units can be adapted to portable control equipment in a limited geographic area. The terminal 5 can then be a personal digital assistant (or PDA) equipped with or connected to a card peripheral device 2. The terminal 5 can, for example, be provided with a low-range link 8, for example of WIFI or bluetooth type. The host device 7 is a transactional device permanently or occasionally connected with the central system of one or more service providers operating on the card 1. Thus, as an example in the field of public transport, such a system is suited to the requirements of the agents performing checks on the value units in the cards on a platform or in the vehicles, the host device 7 then being located on the platform or in the carriages.

In another embodiment, the inventive system for secure transactions of card-borne value units can be adapted to portable control devices in an extended geographic area. The terminal 5 can then be a personal digital assistant (PDA) equipped with or connected to a card peripheral device 2. The terminal 5 can, for example, be provided with a long-range link 8, for example of GPRS or UMTS type. The host device 7 is a transactional device permanently or occasionally connected with the central system of one or more service providers operating on the card 1. Thus, by way of example in the field of public transport, such a system is suited to the requirements of agents performing checks on value units in cards on the platform, in the carriages, at bus stops, the host device 7 then being located at a distance which can be several kilometers. The inventive system according to this embodiment can even be used by the police or by traveling salesmen in the context of collection of secure electronic payments.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A system for secure transactions of value units, borne by a card in the form of protected information, comprising:
a card peripheral device for setting up a link with said card and comprising a transparent mode;
a terminal linked to the card peripheral device by a link;
a host device, linked to the terminal by a link (8), said host device comprising a transactional application suitable for processing the value units on said card, cryptographic means to read and/or write value units and other information on said card;
wherein the card peripheral device operating in transparent mode, the terminal redirects the information originating from or addressed to the card peripheral device to the host device, the host device dialoging with said card via commands and data interchanges via the various links according to communication protocols suited to said card.

2. The system as claimed in claim 1, wherein the host device coordinates the secure interchanges used for mutual authentication with the card.

3. The system as claimed in claim 1, wherein the host device authenticates the holder of the card using means present on the terminal.

4. The system as claimed in claim 1, wherein the host device authenticates the terminal.

5. The system as claimed in claim 1, wherein the card peripheral device is a card reader suitable for reading/writing information on the card, the terminal being a personal computer connected by usual means to the Internet, the host device being a front-end of a central system of one or more service providers operating on the card, the user connects using his personal computer via the link that uses the Internet to the site comprising a transactional application supported by the front-end of his service provider, the transactional application, after insertion of the card of the user into the card reader, proceeding to load the card with the data needed to use the service.

6. The system as claimed in claim 1, wherein the terminal and the card peripheral device are included in a self-service terminal, the host device being a front-end of a central system of one or more service providers operating on the card.

7. The system as claimed in claim 1, wherein the terminal is a personal digital assistant equipped with or connected to a card peripheral device, said terminal being provided with a link, the host device being a transactional device permanently or occasionally connected with the central system of one or more service providers operating on the card.

8. The system as claimed in claim 2, wherein the card peripheral device is a card reader suitable for reading/writing information on the card, the terminal being a personal computer connected by usual means to the Internet, the host device being a front-end of a central system of one or more service providers operating on the card, the user connects using his personal computer via the link that uses the Internet to the site comprising a transactional application supported by the front-end of his service provider, the transactional application, after insertion of the card of the user into the card reader, proceeding to load the card with the data needed to use the service.

9. The system as claimed in claim 3, wherein the card peripheral device is a card reader suitable for reading/writing information on the card, the terminal being a personal computer connected by usual means to the Internet, the host device being a front-end of a central system of one or more service providers operating on the card, the user connects using his personal computer via the link that uses the Internet to the site comprising a transactional application supported by the front-end of his service provider, the transactional application, after insertion of the card of the user into the card reader, proceeding to load the card with the data needed to use the service.

10. The system as claimed in claim 4, wherein the card peripheral device is a card reader suitable for reading/writing information on the card, the terminal being a personal computer connected by usual means to the Internet, the host device being a front-end of a central system of one or more service providers operating on the card, the user connects using his personal computer via the link that uses the Internet to the site comprising a transactional application supported by the front-end of his service provider, the transactional application, after insertion of the card of the user into the card reader, proceeding to load the card with the data needed to use the service.

11. The system as claimed in claim 2, wherein the terminal and the card peripheral device are included in a self-service terminal, the host device being a front-end of a central system of one or more service providers operating on the card.

12. The system as claimed in claim 3, wherein the terminal and the card peripheral device are included in a self-service terminal, the host device being a front-end of a central system of one or more service providers operating on the card.

13. The system as claimed in claim 4, wherein the terminal and the card peripheral device are included in a self-service terminal, the host device being a front-end of a central system of one or more service providers operating on the card.

14. The system as claimed in claim 2, wherein the terminal is a personal digital assistant equipped with or connected to a card peripheral device, said terminal being provided with a link, the host device being a transactional device permanently or occasionally connected with the central system of one or more service providers operating on the card.

15. The system as claimed in claim 3, wherein the terminal is a personal digital assistant equipped with or connected to a card peripheral device, said terminal being provided with a link, the host device being a transactional device permanently or occasionally connected with the central system of one or more service providers operating on the card.

16. The system as claimed in claim 4, wherein the terminal is a personal digital assistant equipped with or connected to a card peripheral device, said terminal being provided with a link, the host device being a transactional device permanently or occasionally connected with the central system of one or more service providers operating on the card.

17. The system as claimed in claim 5, wherein the terminal is a personal digital assistant equipped with or connected to a card peripheral device, said terminal being provided with a link, the host device being a transactional device permanently or occasionally connected with the central system of one or more service providers operating on the card.

18. The system as claimed in claim 6, wherein the terminal is a personal digital assistant equipped with or connected to a card peripheral device, said terminal being provided with a link, the host device being a transactional device permanently or occasionally connected with the central system of one or more service providers operating on the card.
